(19) United States
(12) Patent Application Publication
(10) Pub. No.: US 2020/0355383 A1
(43) Pub. Date: Nov. 12, 2020

(54) WINE CELLAR WITH HUMIDITY CONTROL

(71) Applicant: WHIRLPOOL CORPORATION, Benton Harbor, MI (US)

(72) Inventors: Rodrigues Stahelin, Joinville (BR); Douglas Pauli, Joinville (BR); Matteo Parnisari, Biandronno (IT)

(73) Assignee: WHIRLPOOL CORPORATION, Benton Harbor, MI (US)

(21) Appl. No.: 16/408,976

(22) Filed: May 10, 2019

(51) Int. Cl. F24F 11/00; F24F 6/10; B01D 53/06; B01D 53/26

(52) U.S. Cl. CPC F24F 11/0008; F24F 6/10; B01D 53/06; F24F 2006/008; B01D 2253/106; B01D 2257/80; B01D 53/261

(57) ABSTRACT

A humidity control system for a wine cooler may include a damper configured to control airflow between a cabinet defining an interior and the humidity control system, a heater configured to receive the airflow, a porous medium disposed proximate to the heater, a water inlet configured to selectively supply water to the porous medium and a controller configured to adjust a supply of water to the water inlet. Upon a humidification signal the controller may adjust the damper to allow the passage of airflow from the interior of the cabinet to the heater and the porous medium. The airflow may be humidified via the porous medium and the humidified airflow may be returned to the interior of the cabinet.

### BACKGROUND OF THE DISCLOSURE

The present disclosure generally relates to a humidity control system, and more specifically, to humidity control system for a refrigerating appliance.

Historically, wine cellars are underground, which provides a cool, damp environment for preserving wine. The ideal temperature for long term storage of wine bottles may range from approximately 10° C. to 15° C. (50° F. to 59° F.) and the relative humidity level may range from approximately 50%-70%. Relative humidity levels in this range may prevent the stopper, which is conventionally made from cork, from drying out and damaging the seal. Relative humidity levels above this range can provide an environment for mold growth.

### SUMMARY OF THE DISCLOSURE

According to one aspect of the present disclosure, a humidity control system for a wine cooler includes at least one damper configured to control airflow between a cabinet defining an interior and the humidity control system, a humidity sensor configured to detect and measure a water vapor content of the interior, a heater configured to receive the airflow, a porous medium disposed proximate to the heater, and a water inlet configured to selectively supply water to the porous medium. A controller is configured to control a supply of water to the water inlet. Upon reaching a humidification threshold value the controller adjusts the damper to allow the passage of airflow from the interior of the cabinet to the heater and the porous medium. The airflow is humidified via the porous medium and the humidified airflow is returned to the interior of the cabinet.

According to another aspect of the present disclosure, a humidity control system for a refrigerating appliance includes a damper configured to control airflow between a cabinet defining an interior and the humidity control system, a heater configured to receive the airflow, a porous medium disposed proximate to the heater, and a water inlet configured to selectively supply water to the porous medium. A controller is configured to adjust a supply of water to the water inlet. Upon a humidification signal the controller adjusts the damper to allow the passage of airflow from the interior of the cabinet to the heater and the porous medium. The airflow is humidified via the porous medium and the humidified airflow is returned to the interior of the cabinet.

According to yet another aspect of the present disclosure, a method of controlling a water vapor content of an interior of a refrigerating appliance includes detecting a humidification threshold value, supplying water to a porous medium, directing airflow from the interior to a heater, directing the airflow from the heater to the porous medium for humidification and directing the humidified airflow to the interior.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a perspective view of a wine cooler according to various aspects described herein;

FIG. 2 is a cross-sectional view of the wine cooler of FIG. 1 along line II-II according to various aspects described herein;

FIG. 3 is a schematic view of a humidity control system according to various aspects described herein;

FIG. 4 is a schematic view of a humidity control system according to various aspects described herein;

FIG. 5 is a schematic view of the humidity control system of FIG. 4 according to various aspects described herein;

FIG. 6 is a schematic view of the humidity control system of FIG. 4 according to various aspects described herein;

FIG. 7 is a schematic view of a humidity control system according to various aspects described herein; and

FIG. 8 is a flow chart demonstrating a method of controlling a water vapor content of an interior of a refrigerating appliance according to various aspects described herein.

The components in the figures are not necessarily to scale, emphasis instead being placed upon illustrating the principles described herein.

### DETAILED DESCRIPTION

The present illustrated embodiments reside primarily in combinations of method steps and apparatus components related to a humidity control system for a refrigerating appliance. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

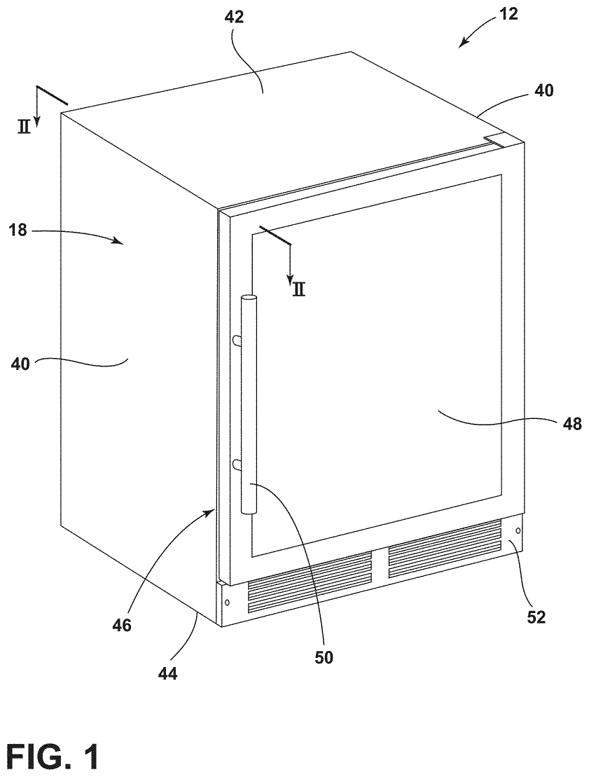

For purposes of description herein, the terms “upper,” “lower,” “right,” “left,” “rear,” “front,” “vertical,” “horizontal,” and derivatives thereof shall relate to the disclosure as oriented in FIG. 1. Unless stated otherwise, the term “front” shall refer to the surface of the element closer to an intended viewer, and the term “rear” shall refer to the surface of the element further from the intended viewer. However, it is to be understood that the disclosure may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The terms “including,” “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises a . . . ” does not, without more constraints, preclude the existence of additional identical elements in the process, method, article, or apparatus that comprises the element.

Referring to FIGS. 1-3, reference numeral 10 generally designates a humidity control system for a refrigerating appliance 12, in the form of a wine cooler. The humidity control system 10 may include a damper 14 configured to control airflow 16 between a cabinet 18 defining a cavity, or an interior 20, and the humidity control system 10. A heater 22 may be provided and configured to receive the airflow 16. A porous medium 24 may be disposed proximate to the heater 22. A water inlet 26 may be configured to selectively supply water to the porous medium 24. A controller 30 may be configured to adjust a supply of water 28 to the water inlet 26. Upon a humidification signal the controller may adjust the damper 14 to allow the passage of airflow 16 from the interior 20 of the cabinet 18 to the heater 22 and the porous medium 24. Then, the airflow 16 may be humidified via the porous medium 24 and the humidified airflow 16 may be returned to the interior 20 of the cabinet 18.

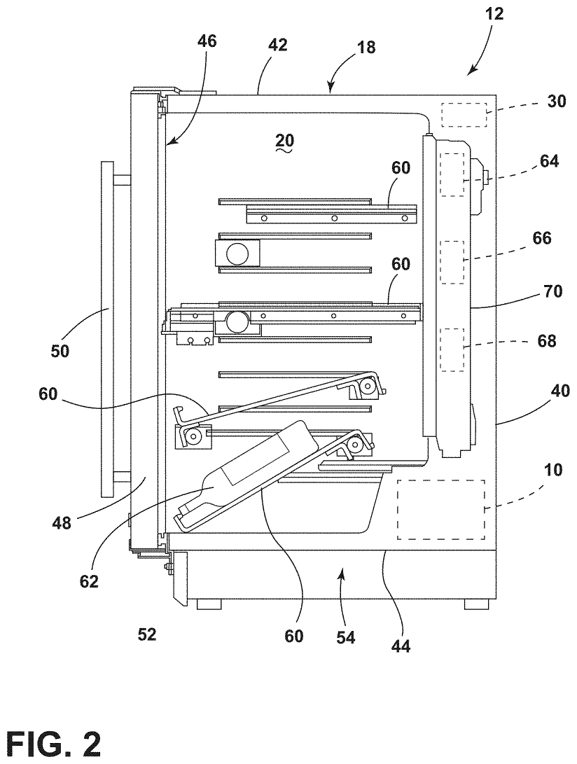

Referring now to FIG. 1, the refrigerating appliance 12 is illustrated. Although the refrigerating appliance 12 is shown as a wine cooler, or wine cellar, the refrigerating appliance 12 may be in the form of any cooling appliance such as a refrigerator, a freezer, and any combination thereof. For example, the refrigerating appliance 12 may include an upper compartment, or cavity, configured for wine storage and a lower compartment configured for freezing. The cabinet 18 may include a plurality of sidewalls 40, a top wall 42 and a bottom wall 44, defining an access opening 46. A door assembly 48 may selectively cover the access opening 46. A handle 50 may be provided to facilitate opening and closing of the door assembly 48 to selectively cover the access opening 46. The refrigerating appliance 12 may further include a grille 52 provided to cover a ventilation space 54 (FIG. 2). It is within the scope of aspects described herein for the refrigerating appliance 12 to include any suitable configuration such that the refrigerating appliance 12 is not limited to the configuration illustrated herein.

FIG. 2 further illustrates the interior 20 of the refrigerating appliance 12 according to various aspects described herein. The interior 20 may include a plurality of racks, or shelves 60, provided for supporting objects such as food, drinks, etc. In some examples, the shelves 60 are configured to support wine bottles 62.

The refrigerating appliance 12 may include a refrigeration system including an evaporator 64 in fluid communication with a compressor 66 and a condenser 68 via fluid control devices such as blowers, valves, tubes, conduits, orifices, dampers and the like. In some examples, the evaporator 64, compressor 66, and condenser 68 are at least partially located within a cooling housing 70. In this way, the refrigeration system may be in the form of a sealed refrigeration system. In some examples, the humidity control system 10 may be positioned at the bottom of the cabinet 18 in between the cabinet 18 and the interior 20. In further examples, the humidity control system 10 is positioned below the cooling housing 70. The controller 30 may be configured to control the components of the refrigeration system order to provide cooling to the interior 20 of the refrigerating appliance 12. Likewise, the controller 30 may be configured to control the humidity control system 10 to provide moisture to the interior 20.

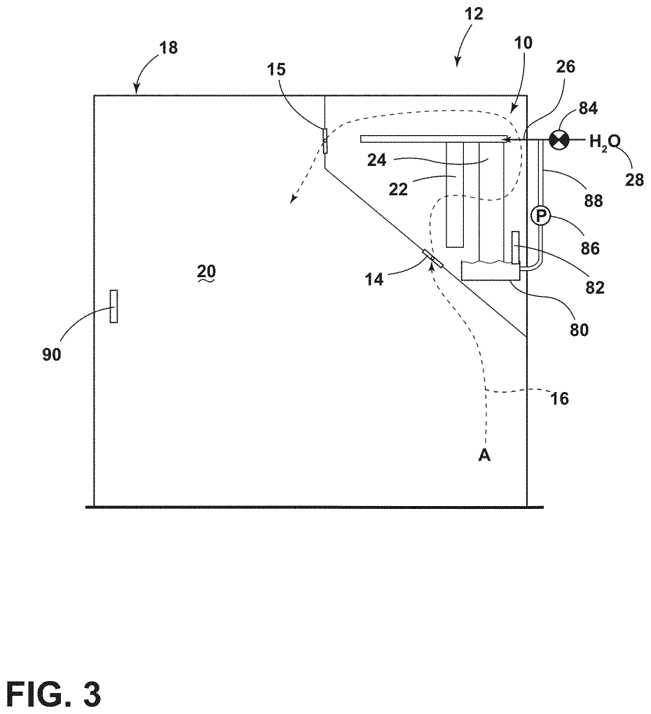

FIG. 3 illustrates a schematic view of the humidity control system 10 according to various aspects described herein. The damper 14 may be in the form of a manual or an electronic damper, which may be provided in the form of a valve, a plate, or any other suitable configuration to regulate the airflow 16. The damper 14 may be positioned at an air outlet of the interior 20 such that the interior 20 may be selectively in fluid communication with the humidity control system 10. In this way, airflow 16 may be directed from the interior 20 to the humidity control system 10 when the damper 14 is in an open position, which may be facilitated via airflow control devices, such as blowers (not shown). It is contemplated that a single blower may direct the airflow 16 in multiple directions, or more than one blower may be provided. Therefore, the airflow 16 may also return to the interior 20 via the damper 14. In some examples, more than one damper 14 may be provided, such that a second damper 15 may direct airflow 16 from the humidity control system 10 to the interior 20.

The heater 22 may be positioned to receive the airflow 16 from the interior 20 in order to increase the capacity of the airflow 16 to absorb water vapor in the surrounding air before the airflow 16 reaches, or is drawn through, the porous medium 24. Thus, the porous medium 24 may be disposed proximate to the heater 22. The heater 22 may be in the form of any suitable heating device, including, but not limited to, a gas heater or an electrical heater. In some examples, heat may not be applied to the airflow 16. The porous medium 24 may be any suitable material configured to retain moisture and does not necessarily include pores, or voids. In some examples, the porous medium 24 may include, but is not limited to, zeolites, silica (i.e. silica gel), cements, ceramics, wood, soil, sand, rocks (i.e. limestone) activated carbon, calcium chloride, lithium chloride, and the like. The water inlet 26 may supply the supply of water 28 to the porous medium 24 to keep the porous medium 24 moist. In some examples, the water inlet 26 may be disposed near an upper portion of the porous medium 24 such that the supply of water 28 may be distributed to the top of the porous medium 24 and may moisten the porous medium 24 via gravity. While described as a supply of water 28, it is within the scope of aspects described herein for the supply of water 28 to include any liquid.

A tray 80 may be positioned below the porous medium 24 to collect water not absorbed by the porous medium 24. The water level in the tray 80 may be monitored by a level sensor 82, which may be in communication with the controller 30 and may provide the controller 30 with data relating to the water level. The level sensor 82 may be in the form of any suitable sensor for detecting the level of liquid in the tray 80 and may include a continuous level sensor or a point-level sensor. In some examples, the water inlet 26 includes a valve 84 that may be adjusted by the controller 30. Therefore, when the water level in the tray 80 reaches a first predetermined threshold level measured by the level sensor 82, the controller 30 may position the valve 84 in a closed position such that water may not overflow from the tray 80. Likewise, in the event that the water level in the tray reaches a second predetermined threshold level, which may be lower than the first predetermined threshold level measured by the level sensor 82, the controller 30 may position the valve 84 in an open position such that the supply of water 28 may humidify the porous medium 24. Additionally, more than one level sensor 82 may be used to measure multiple water point levels. In this way, a first level sensor 82 may communicate the first predetermined threshold level to the controller 30 and a second level sensor 82 may communicate the second predetermined threshold level to the controller 30.

The humidity control system 10 may further include a pump 86 in fluid communication with the water in the tray 80 and the water inlet 26 via a conduit 88. The pump 86 may be configured to pump water from the tray 80 to the water inlet 26 in order to redistribute the water to the porous medium 24 and prevent overflow from the tray 80. In some examples, upon communication of the water level in the tray 80 reaching the first predetermined threshold level to the controller 30, the controller 30 may operate the pump 86 to transfer water from the tray 80 to the water inlet 26.

Various sensors may be disposed within the interior 20 to detect and measure data that can include, but is not limited to, water vapor content in the air, percentage relative humidity of the air, temperature, etc. In some examples, a humidity sensor 90 may be provided. The humidity sensor 90 may be in communication with the controller 30 (FIG. 2) for data processing. In this way, the humidity sensor 90 may communicate a humidification signal to the controller 30. The humidification signal may communicate to the controller 30 that the relative humidity level in the interior 20 is low, and that a humidification cycle should begin. Alternatively, a user input may be provided such that a user may manually signal the controller 30 that a humidification cycle should begin.

Furthermore, the humidity sensor 90 may be configured to detect a humidification threshold value for communicating to the controller 30 that a humidification cycle should begin and a de-humidification threshold value for communicating to the controller 30 that a de-humidification cycle should begin. In some examples, the humidification threshold value is less than approximately 55% relative humidity and the de-humidification threshold value is more than approximately 65% relative humidity. However, the humidification and de-humidification threshold values may be any suitable value, which may include values in the range of 45%-75% relative humidity. In some examples, a user may select a desired percentage of relative humidity as a target level for the interior 20, which may depend on a type of wine that is being stored. The desired percentage of relative humidity may be in the form of a user input, which may be communicated to the controller 30. The controller 30 may compute the humidification and de-humidification threshold values as a function of the selected relative humidity target level.

Upon receiving the humidification signal, which may include reaching or passing a humidification threshold value, the controller 30 may position the damper 14 from a closed position to an open position to direct the airflow 16 to the humidity control system 10 to initiate a humidification cycle. The controller 30 may position the valve 84 in the open or closed positions based on the water vapor content of the interior 20, which may be communicated by the humidity sensor 90. Therefore, upon receiving the humidification signal, the controller may position the valve 84 to an open position such that the supply of water 28 may moisten the porous medium 24. During a humidification cycle, the humidity sensor 90 may be in communication with the controller 30 so that when the target relative percentage humidity is achieved, or detected, the controller 30 may position the damper 14 and/or damper 15 to a closed position to end the humidification cycle. Likewise, the controller 30 may position the valve 84 to a closed position. Additionally, the controller 30 may control the blower(s) for directing the airflow 16 to turn on or off in response to the beginning or ending of a humidification cycle.

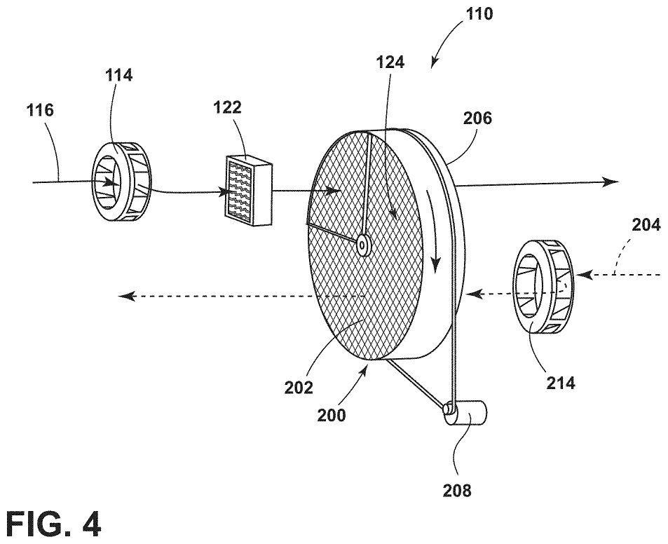

Referring now to FIG. 4, a humidity control system 110 is illustrated. The humidity control system 110, is similar to the humidity control system 10. Therefore, like parts will be identified with like numerals increased by 100. All aspects of the humidity control system 10 may be applicable to the humidity control system 110. According to various aspects described herein, the porous medium 124 of the humidity control system 110 may be provided in a rotatable wheel 200, which may be in the form of a desiccant wheel. In specific examples, the porous medium 124 may be a silica gel. Airflow 116 may be drawn through the heater 122 and a first side 202 of the desiccant wheel 200 for humidification, while airflow 204 may be drawn through a second side 206 of the desiccant wheel 200 for de-humidification. A drive motor 208 may be coupled to the desiccant wheel 200 to selectively rotate the desiccant wheel 200. The drive motor 208 may be in the form of a belt drive or any other suitable drive system for rotating the desiccant wheel 200.

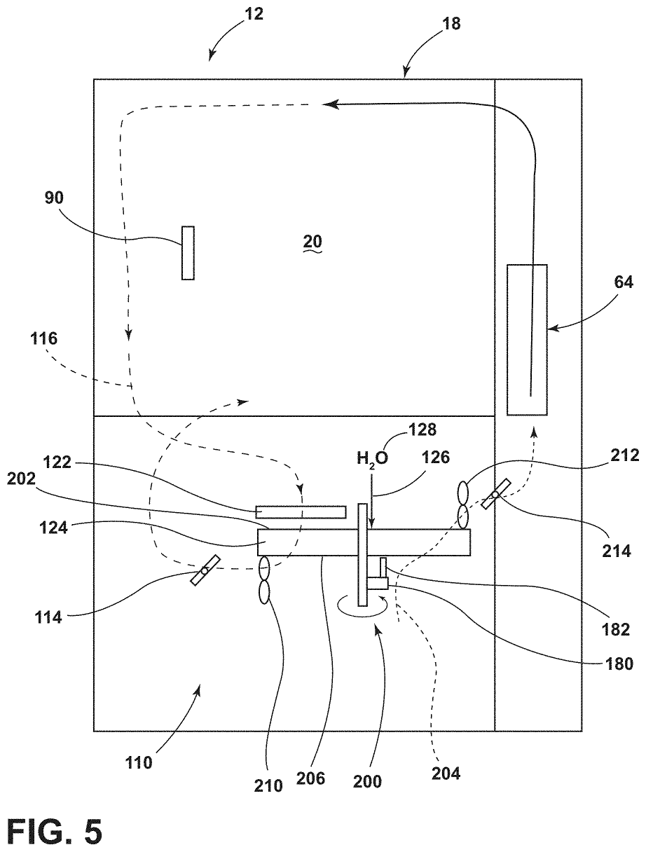

FIG. 5 is a schematic view of the humidity control system 110 further illustrating paths for airflow 116 and 204 during a humidification cycle according to various aspects described herein. Upon receiving the humidification signal, which may include reaching the humidification threshold value, the controller 30 (FIG. 2) may divert airflow 116 from the interior 20 to the humidity control system 110 to initiate a humidification cycle. In some examples, diverting the airflow 116 may include adjusting the damper 114, via the controller 30, from a closed position to an open position to direct the airflow 116. The airflow 116 may be further regulated via a blower 210 configured to draw airflow 116 through the heater 122 and the first side 202 of the desiccant wheel 200. Alternatively, the blower 210 may direct, or blow, airflow 116 through the heater 122 and the first side 202 of the desiccant wheel 200. Additionally, the speed of the blower 210 may be varied for further regulation of the airflow 116.

The desiccant wheel 200 may be humidified via the supply of water 128 from the water inlet 126. In some examples, the supply of water 128 may be directed to a portion of the desiccant wheel 200, which may include an upper portion of the first side 202. Therefore, when the airflow 116 is directed through the first side 202, the airflow 116 may become humidified by capturing moisture in the desiccant wheel 200 and returned to the interior 20 for increasing the relative humidity level of the interior 20. Returning airflow 116 to the interior 20 may include forced ventilation. Water not absorbed by the airflow 116 may collect in the tray 180. As previously described, the water inlet 126 may be controlled based on measurements from the water level sensor 182.

Compartment, or interior 20, return air, such as airflow 204, may be directed through the second side 206 of the desiccant wheel 200. The airflow 204 may be regulated via a blower 212 and a damper 214 configured to draw, or direct, airflow 204 through the second side 206 of the desiccant wheel 200 and to the evaporator 64. The second side 206 may by drier than the first side 202 in order to capture moisture from airflow 204. Thus, de-humidified air may be provided to the evaporator 64 for operation of a standard refrigeration cycle. Providing de-humidified air to the evaporator 64 may prevent the formation of ice and consequently, reduce the number of defrost cycles.

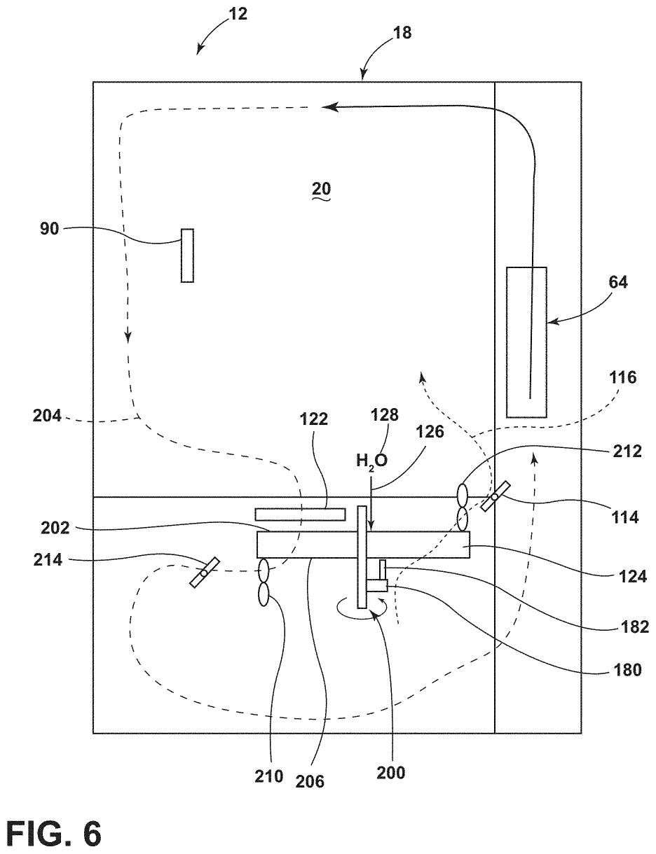

FIG. 6 is a schematic view of the humidity control system 110 further illustrating paths for airflow 116 and 204 during a de-humidification cycle according to various aspects described herein. Upon receiving the de-humidification signal, which may include reaching the de-humidification threshold value, the controller 30 (FIG. 2) may divert airflow 116 from the interior 20 to the humidity control system 110 to initiate a de-humidification cycle. In some examples, diverting the airflow 116 may include adjusting a damper, such as the damper 114, via the controller 30, from a closed position to an open position to direct the airflow 116. The airflow 116 may be further regulated via the blower 210 configured to draw airflow 116 through the heater 122 and the second side 206 of the desiccant wheel 200 and to return the airflow 116 to the interior 20. Alternatively, the blower 210 may direct, or blow, airflow 116 through the second side 206 of the desiccant wheel 200. The speed of the blower 210 may be varied for further regulation of the airflow 116.

In the de-humidification cycle, the desiccant wheel 200 may not be humidified via the supply of water 128 from the water inlet 126. Thus, the valve (FIG. 3) associated with the water inlet 126 may be adjusted to a closed position by the controller 30. Therefore, the second side 206 may by dry in order to capture moisture from the airflow 116. In some examples, the second side 206 may be drier than the first side 202. The de-humidified air may be provided to the interior 20 for reducing the relative humidity level of the interior 20.

Compartment, or interior 20, return air, such as airflow 204, may be directed through the heater 122 and the first side 202 of the desiccant wheel 200. The airflow 204 may be regulated via the blower 212 and the damper 214 configured to draw, or direct, airflow 204 through the first side 202 of the desiccant wheel 200. When airflow 204 is directed through the heater 122 and the first side 202, the airflow 204 may become humidified by capturing the remaining moisture in the desiccant wheel 200 and may then be directed to the evaporator 64 via the damper 214.

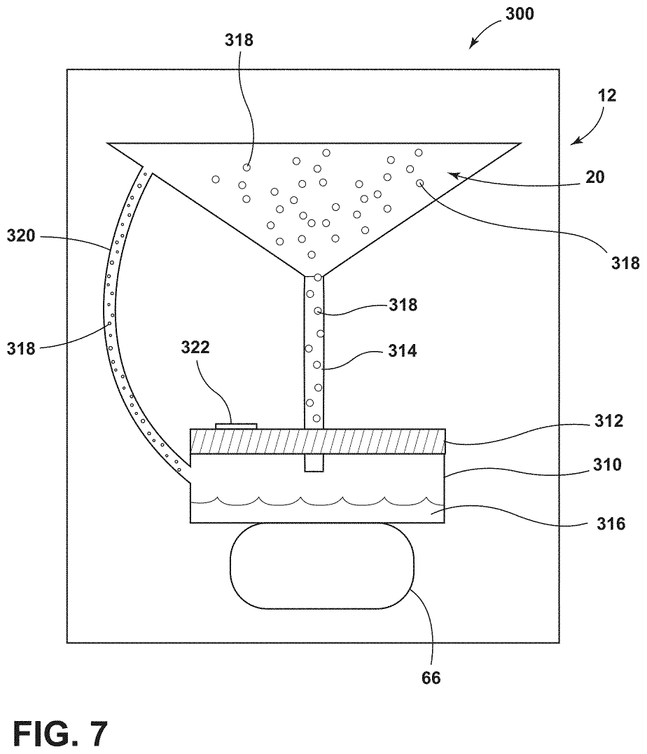

Referring now to FIG. 7, a humidity control system 300 according to various aspects described herein is illustrated. The humidity control system 300 may include a tray 310 coupled to the compressor 66. The tray 310 may include a cover 312, which may be sealed to the top of the tray 310. The refrigerating appliance 12 may include a drain system including a drain pipe 314, which may be in fluid communication with the interior 20 and the tray 310. The drain pipe 314 may collect water 316, or liquid, from a bottom of the interior 20 and direct the water 316 into the tray 310.

In operation, the compressor 66 may provide heat to the tray 310. In this way, water stored in the tray 310 may become heated and evaporation may occur at a faster rate than the rate of evaporation while the compressor 66 is not in operation. As the water 316 evaporates into water vapor 318, the water vapor 318 accumulated in the air may be in communication with the interior 20 via the drain pipe 314. Thus, the interior 20 may become humidified by the water vapor 318 escaping from the tray 310 and entering the interior 20 via the drain pipe 314. In some examples, the humidity control system 300 may further include a conduit 320, which may be in fluid communication with the tray 310 and an upper portion of the interior 20. In this way, the conduit 320 may provide at least a portion of the water vapor 318 to an upper portion of the interior 20 such that the water vapor 318 may be distributed more evenly throughout the interior 20.

As the tray 310 may be an enclosed environment, the water 316 may evaporate until the surrounding air, including the interior 20, is saturated. In the case when the interior 20 includes a relatively low humidity level, the water 316 in the tray 310 may evaporate more quickly. Therefore, it is within the scope of aspects described herein for the cover 312 to be removable such that water 316 may be manually added to the tray 310 to increase humidity levels of the interior 20. Alternatively, the tray 310 may include a sealable orifice 322 for adding water 316.

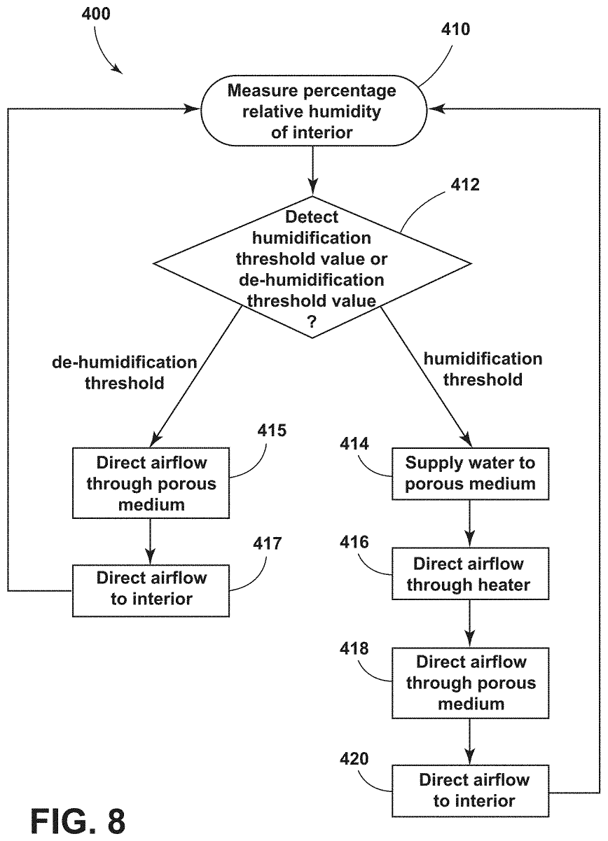

FIG. 8 illustrates a flow chart demonstrating a method 400 of controlling a water vapor content of the interior 20 of the refrigerating appliance 12 according to various aspects described herein. The method 400 may begin at step 410 where the humidity control system 10, 110, may measure or detect the percentage of relative humidity of the interior 20. Step 410 may include the use of the humidity sensor 90. Next, at step 412, the controller 30 may process data relating to the percentage of relative humidity of the interior 20 and determine whether or not either the humidification threshold value or the de-humidification threshold value have been reached or passed.

If the humidification threshold value has been detected, the method 400 may proceed to step 414 where water may be supplied to a porous medium. Next, at step 416, the controller 30 may operate components of the humidity control system 10, 110 to direct airflow through a heater in order to increase the capacity for the airflow to absorb water. Then, at step 416, the airflow may be directed through the moistened porous medium where the airflow may become humidified. The humidified airflow may be returned, or directed, to the interior 20 at step 420 where the method 400 can begin again at step 410.

If the de-humidification threshold value has been detected at step 412, the method 400 may proceed to step 415 where airflow may be directed through the porous medium. At step 415, the porous medium may be drier than the porous medium at step 418. In this way, the airflow may become de-humidified at step 415. Next, at step 417, the de-humidified airflow may be returned, or directed, to the interior 20 where the method 400 may begin again at step 410.

While the method 400 is described as including steps 410-420, it is possible for the method 400 to include additional or fewer steps. Additional steps may include any suitable step or process as described herein. Additionally, the steps 410-420 in the method 400 may occur in an order other than the order illustrated in FIG. 8. In some examples, the method 400 may include collecting excess water from the porous medium and pumping the excess water onto the porous medium. Furthermore, supplying water to the porous medium at step 414 may occur prior to the determination at step 412, or may not be included in the method 400.

Benefits of various aspects described herein may solve the problem of long term moisture loss inside of a refrigerating appliance, such as a wine cooler. Active moisture control in a wine cooler may enable the preservation of wine. In some aspects, a user may select the percentage of relative humidity desired for the type of wine that will be stored. Furthermore, the number of times a defrost cycle is run in a refrigerating appliance may be reduced due to a reduction of temperature swing during a humidification cycle according to various aspects described herein.

According to one aspect of the present disclosure, a humidity control system for a wine cooler may include at least one damper configured to control airflow between a cabinet defining an interior and the humidity control system, a humidity sensor configured to detect and measure a water vapor content of the interior, a heater configured to receive the airflow, a porous medium disposed proximate to the heater, and a water inlet configured to selectively supply water to the porous medium. A controller may be configured to control a supply of water to the water inlet. Upon reaching a humidification threshold value the controller may adjust the damper to allow the passage of airflow from the interior of the cabinet to the heater and the porous medium. The airflow may be humidified via the porous medium and the humidified airflow may be returned to the interior of the cabinet.

According to another aspect of the present disclosure, upon reaching the humidification threshold value water may be supplied to the porous medium.

According to another aspect of the present disclosure, airflow may be directed through a moistened side of the porous medium.

According to another aspect of the present disclosure, upon reaching a de-humidification threshold value the controller may adjust a second damper to allow the passage of airflow from the interior of the cabinet to the porous medium and the airflow may be de-humidified via the porous medium. The de-humidified airflow may be returned to the interior of the cabinet.

According to another aspect of the present disclosure, airflow may be directed through a dry side of the porous medium.

According to another aspect of the present disclosure, the porous medium is a rotatable porous medium and the supply of water may be provided to an upper portion of the porous medium to moisten the porous medium via gravity.

According to another aspect of the present disclosure, the humidity control system may further include a tray proximate to the porous medium. The tray may be configured to collect water.

According to another aspect of the present disclosure, the humidity control system may further include a level sensor configured to measure a water level in the tray and a pump may be configured to pump water from the tray to the porous medium. The controller may be configured to control the pump to supply water to the porous medium based on the water level in the tray.

According to another aspect of the present disclosure, the humidification threshold value is less than approximately 55% relative humidity.

According to another aspect of the present disclosure, the de-humidification threshold value is more than approximately 65% relative humidity.

According to yet another aspect of the present disclosure, a humidity control system for a refrigerating appliance may include a damper configured to control airflow between a cabinet defining an interior and the humidity control system, a heater configured to receive the airflow, a porous medium disposed proximate to the heater, and a water inlet configured to selectively supply water to the porous medium. A controller may be configured to adjust a supply of water to the water inlet. Upon a humidification signal the controller may adjust the damper to allow the passage of airflow from the interior of the cabinet to the heater and the porous medium. The airflow may be humidified via the porous medium and the humidified airflow may be returned to the interior of the cabinet.

According to another aspect of the present disclosure, the humidity control system may further include a humidity sensor configured to detect and measure a water vapor content of the interior.

According to another aspect of the present disclosure, the humidity control system may further include a user input configured to communicate the humidification signal to the controller.

According to another aspect of the present disclosure, the supply of water may be provided to an upper portion of the porous medium and the water may moisten the porous medium via gravity.

According to another aspect of the present disclosure, the humidity control system may further include a tray proximate to the porous medium, the tray configured to collect water.

According to another aspect of the present disclosure, the humidity control system may further include a level sensor configured to measure a water level in the tray and the controller may be configured to adjust the supply of water to the water inlet according to the water level in the tray.

According to another aspect of the present disclosure, the controller may be configured to control the supply of water to the water inlet based on the water vapor content of the interior of the cabinet.

According to yet another aspect of the present disclosure, a method of controlling a water vapor content of an interior of a refrigerating appliance may include detecting a humidification threshold value, supplying water to a porous medium, directing airflow from the interior to a heater, directing the airflow from the heater to the porous medium for humidification and directing the humidified airflow to the interior.

According to another aspect of the present disclosure, supplying water to the porous medium may further include providing a rotatable desiccant wheel.

According to another aspect of the present disclosure, the method of controlling a water vapor content of an interior of a refrigerating appliance may further include collecting excess water from medium drain pipe in fluid communication with a tray and providing water vapor to an upper portion of the interior via a conduit coupled with the tray.

It will be understood by one having ordinary skill in the art that construction of the described disclosure and other components is not limited to any specific material. Other exemplary embodiments of the disclosure disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It is also important to note that the construction and arrangement of the elements of the disclosure as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

The various illustrative logical blocks, modules, controllers, and circuits described in connection with the embodiments disclosed herein may be implemented or performed with application specific integrated circuits (ASICs), field programmable gate arrays (FPGAs), general purpose processors, digital signal processors (DSPs) or other logic devices, discrete gates or transistor logic, discrete hardware components, or any combination thereof designed to perform the functions described herein. A general purpose processor may be any conventional processor, controller, microcontroller, state machine or the like. A processor may also be implemented as a combination of computing devices, e.g., a combination of a DSP and a microprocessor, a plurality of microprocessors, one or more microprocessors in conjunction with a DSP core, or any other such configuration.

It will be understood that any described processes or steps within described processes may be combined with other disclosed processes or steps to form structures within the scope of the present disclosure. The exemplary structures and processes disclosed herein are for illustrative purposes and are not to be construed as limiting.

What is claimed is:

1. A humidity control system fora wine cooler, the humidity control system comprising:
at least one damper configured to control airflow between a cabinet defining an interior and the humidity control system;
a humidity sensor configured to detect and measure a water vapor content of the interior,
a heater configured to receive the airflow;
a porous medium disposed proximate to the heater;
a water inlet configured to selectively supply water to the porous medium; and
a controller configured to control a supply of water to the water inlet, wherein upon reaching a humidification threshold value the controller adjusts the damper to allow the passage of airflow from the interior of the cabinet to the heater and the porous medium and wherein the airflow is humidified via the porous medium and the humidified airflow is returned to the interior of the cabinet.

2. The humidity control system of claim 1, wherein upon reaching the humidification threshold value water is supplied to the porous medium.

3. The humidity control system of claim 1, wherein airflow is directed through a moistened side of the porous medium.

4. The humidity control system of claim 1, wherein upon reaching a de-humidification threshold value the controller adjusts a second damper to allow the passage of airflow from the interior of the cabinet to the porous medium and wherein the airflow is de-humidified via the porous medium and the de-humidified airflow is returned to the interior of the cabinet.

5. The humidity control system of claim 4, wherein airflow is directed through a dry side of the porous medium.

6. The humidity control system of claim 1, wherein the porous medium is a rotatable porous medium and the supply of water is provided to an upper portion of the porous medium to moisten the porous medium via gravity.

7. The humidity control system of claim 1, further comprising:
a tray proximate to the porous medium, the tray configured to collect water.

8. The humidity control system of claim 7, further comprising:
a level sensor configured to measure a water level in the tray; and
a pump configured to pump water from the tray to the porous medium, wherein the controller is configured to control the pump to supply water to the porous medium based on the water level in the tray.

9. The humidity control system of claim 1, wherein the humidification threshold value is less than approximately 55% relative humidity.

10. The humidity control system of claim 4, wherein the de-humidification threshold value is more than approximately 65% relative humidity.

11. A humidity control system for a refrigerating appliance, the humidity control system comprising:
a damper configured to control airflow between a cabinet defining an interior and the humidity control system;
a heater configured to receive the airflow;
a porous medium disposed proximate to the heater;
a water inlet configured to selectively supply water to the porous medium; and
a controller configured to adjust a supply of water to the water inlet and upon a humidification signal the controller adjusts the damper to allow the passage of airflow from the interior of the cabinet to the heater and the porous medium and wherein the airflow is humidified via the porous medium and the humidified airflow is returned to the interior of the cabinet.

12. The humidity control system of claim 11, further comprising:
a humidity sensor configured to detect and measure a water vapor content of the interior.

13. The humidity control system of claim 11, further comprising:
a user input configured to communicate the humidification signal to the controller.

14. The humidity control system of claim 11, wherein the supply of water is provided to an upper portion of the porous medium and the water moistens the porous medium via gravity.

15. The humidity control system of claim 11, further comprising:
a tray proximate to the porous medium, the tray configured to collect water.

16. The humidity control system of claim 15, further comprising:
a level sensor configured to measure a water level in the tray; and
wherein the controller is configured to adjust the supply of water to the water inlet according to the water level in the tray.

17. The humidity control system of claim 12, wherein the controller is configured to control the supply of water to the water inlet based on the water vapor content of the interior of the cabinet.

18. A method of controlling a water vapor content of an interior of a refrigerating appliance, the method comprising:
detecting a humidification threshold value;
supplying water to a porous medium;
directing airflow from the interior to a heater;
directing the airflow from the heater to the porous medium for humidification; and
directing the humidified airflow to the interior.

19. The method of controlling a water vapor content of an interior of a refrigerating appliance of claim 18, wherein the supplying water to the porous medium further includes:
providing a rotatable desiccant wheel.

20. The method of controlling a water vapor content of an interior of a refrigerating appliance of claim 18, further comprising:
collecting excess water from a drain pipe in fluid communication with a tray; and
providing water vapor to an upper portion of the interior via a conduit coupled with the tray.
